(19) United States
(12) Patent Application Publication
(10) Pub. No.: US 2019/0047542 A1
(43) Pub. Date: Feb. 14, 2019

(54) ELECTRIC TAG AXLE

(71) Applicant: International Truck Intellectual Property Company, LLC, Lisle, IL (US)

(72) Inventor: Grzegorz Siuchta, Des Plaines, IL (US)

(73) Assignee: International Truck Intellectual Property Company, LLC, Lisle, IL (US)

(21) Appl. No.: 15/882,491

(22) Filed: Jan. 29, 2018

Related U.S. Application Data
(60) Provisional application No. 62/543,759, filed on Aug. 10, 2017.

(51) Int. Cl. B60W 20/10; B60K 6/52; B60K 6/547; B60K 17/16; B60K 17/356; B60K 17/36; B60L 7/10; F16H 37/08; B60K 6/48

(52) U.S. Cl. CPC B60W 20/10; Y10S 903/919; B60K 6/547; B60K 17/165; B60K 17/356; B60K 17/36; B60L 7/10; F16H 37/0813; B60K 6/48; B60Y 2200/1422; B60Y 2200/92; B60Y 2300/70; F16H 2200/0034; Y10S 903/916; Y10S 903/945; B60K 6/52

(57) ABSTRACT

An Electric Tag Axle has a differential connected to two axle shafts. A two speed gearbox is connected to the differential by way of a ring and pinion gear. A longitudinally arranged electric motor/generator is connected to the two speed gearbox. A single wheel disconnect mechanism within the axle allows for neutral operation by allowing the differential to freewheel. A vehicle energy management system is connected to the Electric Tag Axle and to a traction battery pack, and is configured to operate the Electric Tag Axle in a low range motoring mode, a high range motoring mode, a regenerative braking mode, and in the neutral mode. This allows the Electric Tag Axle are able to efficiently make use of a limited amount of stored electrical energy during vehicle takeoff, while efficiently supplementing propulsion power during motoring at cruise speeds, and while efficiently recapturing kinetic energy during regenerative braking.

### BACKGROUND

Embodiments described herein generally relate to an Electric Tag Axle, and a vehicle energy management system and method for the use thereof.

### RELATED ART

A vehicle, such as a truck, a bus, and the like, is often provided with an engine, a transmission, and one or more drive axles. In order to provide support and traction, it is known to provide two or more rear drive axles, sometimes in conjunction with one or more non-driving axles, at the rear of the vehicle. In order to propel the vehicle, the engine produces rotational torque and power. The transmission receives rotational torque and power from the engine and is equipped with several gear ratios, in order to adapt the torque and power-producing characteristics of the engine to the propulsion and acceleration needs of the vehicle. The transmission then outputs the rotational torque and power to a propeller shaft, which delivers it to the one or more rear drive axles.

It is further known to provide a power divider or inter-axle differential to divide the rotational power between the foremost driving rear axle and any one or more subsequent driving rear axle. The power divider or inter-axle differential may be attached to the front driving rear axle, and may deliver power to the front driving rear axle by way of a direct connection, such as gearing, and may deliver power to the rearward driving rear axle by way of an inter-axle shaft. The power divider or inter-axle differential may further function to deliver rotational power to the front driving rear axle and to the rearward driving rear axle while compensating for any differences in rotational speed of between the front driving rear axle and the rearward driving rear axle. Additionally, the power divider or inter-axle differential may selectively couple or lock together the rotational speeds of the front driving rear axle and of the rearward driving rear axle, for example under low traction conditions.

Each of the frontward and rearward driving rear axles may additionally be provided with differential gears, in order to compensate for differences between the rotational speed of the wheels on one side of the vehicle and the rotational speed of the wheels on the other side of the vehicle, such as differences in rotational speed encountered when the vehicle turns. Each of these differential gears of the frontward and rearward driving rear axles may further be provided with locks or couplings that constrain the wheels on one side of the vehicle and the wheels on the other side of the vehicle to rotate at the same speed, for example under low traction conditions.

It is further known to provide a mechanism that selectively connects or disconnects the power divider or inter-axle differential from the inter-axle shaft, and/or selectively connects or disconnects the inter-axle shaft from the rearward driving rear axle, so that power is selectively delivered to both the front driving rear axle and the rearward driving rear axle, or only to the front driving rear axle. A vehicle having this feature and configuration may be said to be operable both in 6×4 mode wherein both the front driving rear axle and the rearward driving rear axle receive power, and in 6×2 mode wherein only the front driving rear axle receives power. For example, such a vehicle may select 6×4 mode at startup, on grades, at low speeds, during backup maneuvering, or under other conditions where additional traction is needed, and may select 6×2 mode for highway cruise operation.

It is further known to supplement vehicle propulsion using an electric motor and batteries. A vehicle that uses both a conventional internal combustion engine, and an electric motor and batteries to supplement the power produced by the internal combustion engine, may be referred to as a hybrid electric vehicle. Hybrid electric vehicles attempt to increase overall energy efficiency by recapturing kinetic energy during braking, which is known as regenerative braking. However, a heavy commercial vehicle is sometimes limited in the amount of battery energy storage due to the weight and size of traction batteries. As a result, an electric motor that is sized and geared to make efficient use of the limited amount of stored electrical energy during vehicle takeoff, may not be appropriately sized and geared to efficiently recapture kinetic energy during braking.

Accordingly, there is an unmet need for a system and method for efficiently using a limited amount of stored electrical energy during vehicle takeoff of a heavy commercial vehicle, and for efficiently recapturing kinetic energy during braking, while further meeting the need to have a heavy commercial vehicle that can operate in both 6×4 mode for additional traction and 6×2 mode for efficiency when in highway cruise operation.

### SUMMARY

According to one embodiment of the Electric Tag Axle, a vehicle includes a chassis, an engine attached to the chassis, a transmission connected to the engine, and a forward rear drive axle attached to the chassis and driven by the transmission. An electric tag axle is also attached to the chassis. The electric tag axle has a longitudinally arranged electric motor/generator connected to a two speed gearbox. The two speed gearbox is connected to a differential of the electric tag axle.

According to another embodiment of the Electric Tag Axle, the Electric Tag Axle has an axle housing and a differential contained within the axle housing and connected to two axle shafts. A two speed gearbox is connected to the differential by way of a ring gear and a pinion gear. A longitudinally arranged electric motor/generator is connected to the two speed gearbox.

According to another embodiment of the Electric Tag Axle, a method of controlling the electric tag axle includes several steps. The first step is connecting a two speed gearbox to a differential of the electric tag axle by way of a ring gear and a pinion gear, the differential being connected to two axle shafts. The second step is connecting a longitudinally arranged electric motor/generator to the two speed gearbox. The third step is connecting at least one single wheel disconnect mechanism to at least one of the two axle shafts. The fourth step is connecting a vehicle energy management system to an engine of the vehicle, a transmission of the vehicle, a traction battery pack of the vehicle, the electric motor/generator, the two speed gearbox, and/or the at least one single wheel disconnect mechanism. The fifth step is configuring the vehicle energy management system to take at least one of four sub-steps. The first sub-step is engaging the electric motor/generator to provide power to the electric tag axle using energy stored in the traction battery pack, and placing the two speed gearbox in low gear in a low range motoring mode, and controlling the amount of power being provided by the electric motor/generator. The second sub-step is engaging the electric motor/generator to provide power to the electric tag axle using energy stored in the traction battery pack, and placing the two speed gearbox in high gear in high range motoring mode, and controlling the amount of power being provided by the electric motor/generator. The third sub-step is engaging the electric motor/generator and placing the two speed gearbox in high gear to recapture power from the electric tag axle and store the recaptured power in the traction battery pack in a regenerative braking mode, and controlling the amount of power being recaptured by the electric motor/generator. The fourth sub-step is disengaging the at least one single wheel disconnect mechanism in a neutral mode.

### DESCRIPTION OF THE DRAWINGS

FIG. 1 is a top view of an embodiment of a vehicle having an Electric Tag Axle, as described herein;

FIG. 2 is a graph of desired gear ratio and disconnect speed versus electric motor/generator stall torque of an embodiment of an Electric Tag Axle, as described herein;

FIG. 3 is a graph of operation modes speed ranges of an embodiment of an Electric Tag Axle, as described herein;

FIG. 4 is a spreadsheet comparison of electric motor/generator performance specifications;

FIG. 5 is a graphical representation of an embodiment of an Electric Tag Axle, as described herein;

FIG. 6 is a top right cutaway view of an embodiment of an Electric Tag Axle, as described herein; and

FIG. 7 is a left cutaway view of an embodiment of an Electric Tag Axle, as described herein.

### DETAILED DESCRIPTION

Embodiments described herein relate to an Electric Tag Axle, and a vehicle energy management system and method for the use thereof. The Electric Tag Axle may be applied to various types of vehicles, such as highway or semi-tractors, straight trucks, busses, fire trucks, agricultural vehicles, and etcetera. The several embodiments of the Electric Tag Axle presented herein are employed on vehicles having a traditional ladder frame and rigid axles as examples, but this is not to be construed as limiting the scope of the Electric Tag Axle, and vehicle energy management system and method for the use thereof, which may be applied to vehicles and axle/suspension systems of differing construction. The vehicle energy management system may be part of an Auxiliary Power Unit arrangement, or may be a stand-alone system. The several embodiments of the Electric Tag Axle presented herein are further employed on a tag axle having a Gross Axle Weight Rating (GAWR) of 20,000 pounds, with a target fully dressed axle weight of about 1,000 pounds, but again this is not to be construed as limiting the scope of the Electric Tag Axle, which may be employed on considerably heavier or lighter tag axles.

More specifically, embodiments of the Electric Tag Axle may use a tag axle mounted longitudinally arranged single 20 kilowatt (kW) continuous/28 KW peak shaft power, 21 KW continuous/30 kW peak power charging electric motor/generator. An electric motor/generator of these specifications may be obtained from Parker Hannifin Corporation of Cleveland, Ohio, as model number GVK210-100W6. The Electric Tag Axle may further include a two speed gearbox. The electric motor/generator is connected to, for non-limiting example, a 48 volt direct current (DC) traction battery pack, and is connected to and controlled by a vehicle energy management system that may include one or more vehicle, transmission, engine, and/or axle controllers. The vehicle energy management system and electric motor/generator to traction battery pack connection may use predefined electrical and controls interfaces, wherein the vehicle maintains supervisory control over the electric motor/generator and over certain clutches and/or gear selectors within the two speed gearbox and/or within the tag axle. The predefined controls interfaces may further utilize defined Closed Area Network (CAN) signal control parameters broadcast between the Electric Tag Axle and the vehicle energy management system. Certain control parameters may be controlled by one vehicle, transmission, engine, and/or axle controller, while another control parameter may be controlled by another vehicle, transmission, engine, and/or axle controller.

The choice of a 48 volt DC traction battery pack provides a reasonable amount of power storage within available space and weight constraints of commercial vehicles. The choice of a single 20 kW continuous/28 KW peak shaft power, 21 KW continuous/30 kW peak power charging electric motor/generator maximizes the performance and efficiency of the electric motor/generator within weight and size constraints imposed by the longitudinal axle mounted configuration of the electric motor/generator and by un-sprung mass considerations. However, these same specification choices also limit the maximum speed and torque characteristics of the electric motor/generator, and the maximum rate at which the 48 volt DC traction battery pack can accept a charge. Specifically, the Parker GVK210-100W6 electric motor/generator is capable of 96 Newton-meters (Nm) of torque continuous and 169 Nm of torque peak, and a maximum continuous motor speed of 3000 RPM. This requires a very high gear ratio of between 50:1 and 80:1 in order to provide 6×2 traction support, or in other words to emulate a 6×4 drive mode, and a very low disconnect speed of between 5 and 10 miles per hour (MPH). The very low disconnect speed may make a single ratio solution non-viable for regenerative braking.

Thus, the Electric Tag Axle is provided with a two speed gearbox with a range selector and/or one or more clutches connected to and controlled by the vehicle energy management system. The ring and pinion of the tag axle itself provides a reduction of 4.35:1. The two speed gearbox can selectively provide a 1:1 ratio, or a 14.9:1 reduction by way of two 3.866:1 gear pairs. This gives an overall reduction from electric motor/generator to drive wheel of either 4.35:1 in high gear or 65:1 in low gear. The vehicle energy management system may engage the electric motor/generator to provide power to the Electric Tag Axle using energy stored in the 48 volt DC traction battery pack, and may place the two speed gearbox in low gear when additional traction and/or boosted acceleration is desired, such as when operating in slippery road conditions, for example when the coefficient of friction between the drive wheel tires and the road is less than 0.5. Such low gear operation of the Electric Tag Axle may, for example, take place during vehicle launch and up to about six MPH. In this way, the Electric Tag Axle emulates a 6×4 driving arrangement, with the vehicle energy management system controlling the amount of power being provided by the electric motor/generator.

The vehicle energy management system may further engage the electric motor/generator to provide power to the Electric Tag Axle using energy stored in the 48 volt DC traction battery pack, and may place the two speed gearbox in high gear when motoring at cruise speeds, up to about 70 MPH, in order to provide supplemental power in cruising mode, with the amount of supplemental power being provided controlled by the vehicle energy management system. Similarly, the vehicle energy management system may engage the electric motor/generator and place the two speed gearbox in high gear to recapture power from the Electric Tag Axle and store the recaptured power in the 48 volt DC traction battery pack when in a regenerative braking mode, again with the amount of power being recaptured being controlled by the vehicle energy management system. Such regenerative braking mode may, for non-limiting example, take place with the vehicle transmission in gears four through six.

In order to minimize friction drag losses when the electric motor/generator is not being used to provide power to the Electric Tag Axle, or is not being used to recapture power during regenerative braking, the Electric Tag Axle may further be provided with at least one single wheel disconnect mechanism connected to and controlled by the vehicle energy system. The at least one single wheel disconnect mechanism is connected to at least one of the axle shafts of the Electric Tag Axle, and allows the spider gears of the tag axle differential to freewheel, thereby providing a neutral mode, minimizing friction drag losses, and minimizing wear and tear on the two speed gearbox and electric motor/generator. The at least one single wheel disconnect mechanism may be embodied as two single wheel disconnect mechanisms, one in each axle shaft of the Electric Tag Axle. In this way, when the two single wheel disconnect mechanisms are disengaged, the spider gears of the tag axle differential remain relatively stationary.

The vehicle energy system, therefore, may disengage the at least one single wheel disconnect mechanism when the electric motor/generator is neither being used to provide power to the Electric Tag Axle, nor being used to recapture power from the Electric Tag Axle. Note that in an aforementioned embodiment wherein certain control parameters are controlled by one vehicle, transmission, engine, and/or axle controller, while another control parameter is controlled by another vehicle, transmission, engine, and/or axle controller, an exemplary arrangement may be where a vehicle controller commands the operation mode between low gear, high gear, and neutral, and further controls the desired electric motor/generator power, whereas an axle controller controls the transition between modes by way of the range selector and/or one or more clutches.

Embodiments of the Electric Tag Axle are able to efficiently make use of a limited amount of stored electrical energy during vehicle takeoff, while efficiently supplementing propulsion power during motoring at cruise speeds, and while efficiently recapturing kinetic energy during regenerative braking. Embodiments of the Electric Tag Axle further meet the need to have a heavy commercial vehicle that can operate in both 6×4 mode for additional traction, and in 6×2 mode for efficiency when in highway cruise operation.

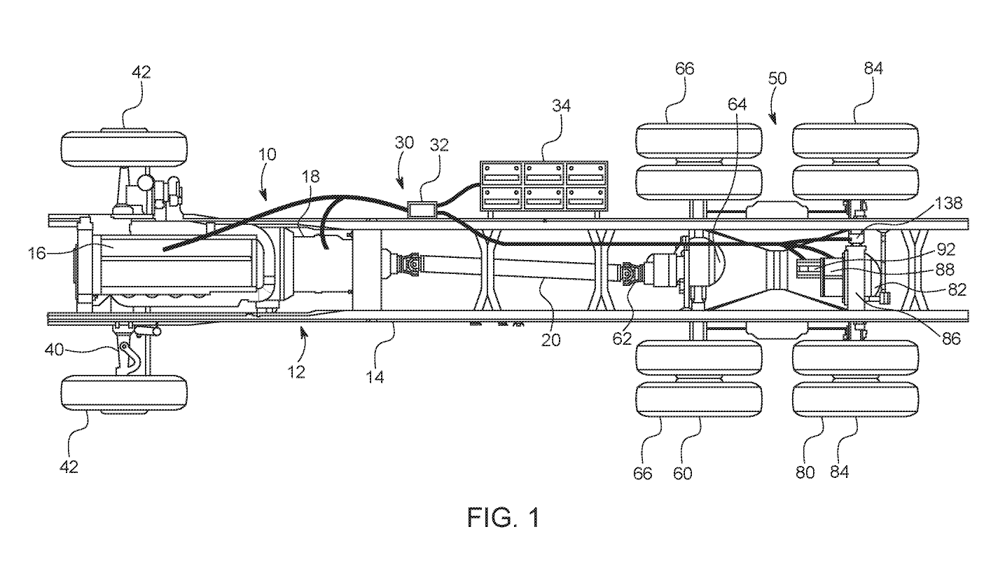

Referring now to FIG. 1, a top view of a vehicle 10 having an embodiment of an Electric Tag Axle 80 is shown. The vehicle 10 includes a chassis 12 having a frame 14, to which is attached a front driving or non-driving axle 40 having front wheels 42, a forward rear drive axle 60 with forward rear wheels 66, and an Electric Tag Axle 80 having rearward rear wheels 84. An engine 16 provides power for propulsion by way of a transmission 18 and a driveshaft 20, which is connected to a forward rear drive axle input 62 of the forward rear drive axle 60. The forward rear drive axle 60 is provided with a forward rear drive axle differential 64, which serves to distribute power to the forward rear wheels 66, while allowing for differences in the rotation thereof, such as during cornering. The Electric Tag Axle 80 is provided with an electric motor/generator 92, which is connected to a two speed gearbox 88. The two speed gearbox 88 is connected to an electric tag axle differential 82, which electric tag axle differential 82 is contained within the axle housing 86 of the Electric Tag Axle 80. The Electric Tag Axle 80 may be further provided with at least one single wheel disconnect mechanism 138, which may be connected to at least one axle shaft contained within the axle housing 86. The at least one single wheel disconnect mechanism 138 may be embodied as two single wheel disconnect mechanisms, one in each axle shaft of the Electric Tag Axle.

A vehicle energy management system 30 may include one or more vehicle, transmission, engine, and/or axle controllers 32, and a traction battery pack 34, which may be, for example, a 48 volt DC traction battery pack. The one or more vehicle, transmission, engine, and/or axle controllers 32 may be connected to the engine 16, to the transmission 18, to the traction battery pack 34, to the electric motor/generator 92, to the two speed gearbox 88, and/or to the at least one single wheel disconnect mechanism 138. The controller or controllers 32 of the vehicle energy management system 30 may be configured to engage the electric motor/generator 92 to provide power to the Electric Tag Axle 80 using energy stored in the traction battery pack 34, and may place the two speed gearbox 88 in low gear in the low range motoring mode when additional traction and/or boosted acceleration is desired, while controlling the amount of power being provided by the electric motor/generator 92.

The controller or controllers 32 of the vehicle energy management system 30 may further be configured to engage the electric motor/generator 92 to provide power to the Electric Tag Axle 80 using energy stored in the traction battery pack 34, and may place the two speed gearbox 88 in high gear, in order to provide supplemental power in high range motoring mode, with the amount of supplemental power being provided by the electric motor/generator 92 controlled by the vehicle energy management system 30. Similarly, the controller or controllers 32 of the vehicle energy management system 30 may further be configured to engage the electric motor/generator 92 and place the two speed gearbox 88 in high gear to recapture power from the Electric Tag Axle 80 and store the recaptured power in the traction battery pack 34 when in a regenerative braking mode, again with the amount of power being recaptured being controlled by the vehicle energy management system 30. The controller or controllers 32 of the vehicle energy system 30 may further be configured to disengage the at least one single wheel disconnect mechanism 138 in neutral mode when the electric motor/generator 92 is neither being used to provide power to the Electric Tag Axle 80, nor being used to recapture power from the Electric Tag Axle 80. As noted previously, the at least one single wheel disconnect mechanism 138 allows the spider gears of the tag axle differential 82 to freewheel, thereby providing the neutral mode, minimizing friction drag losses, and minimizing wear and tear on the two speed gearbox 88 and electric motor/generator 92.

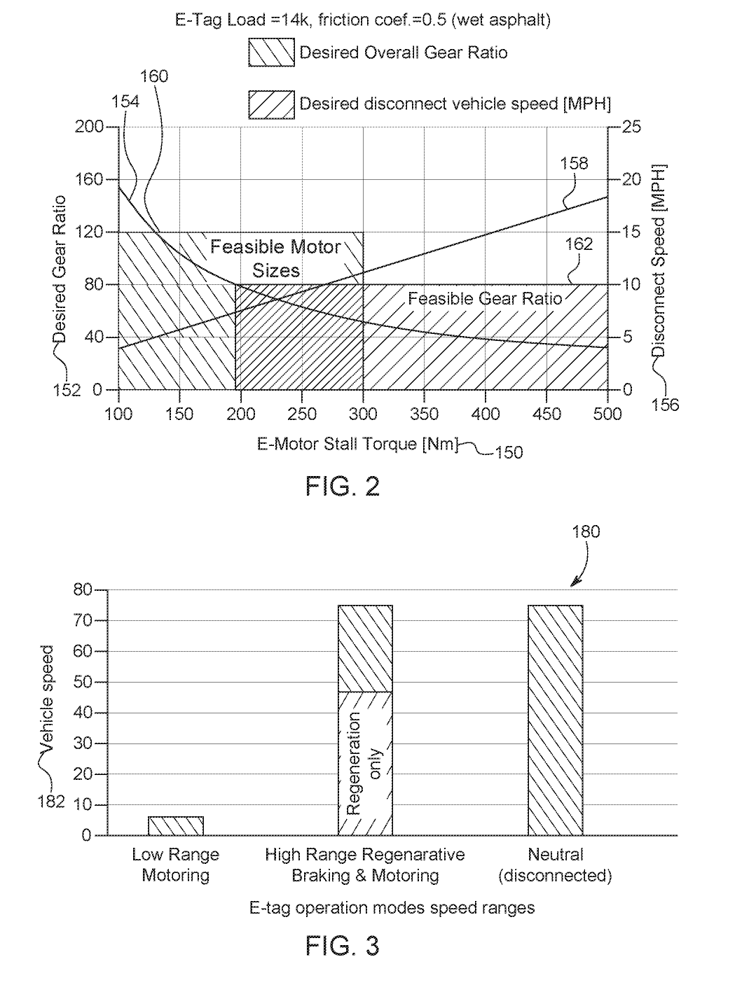

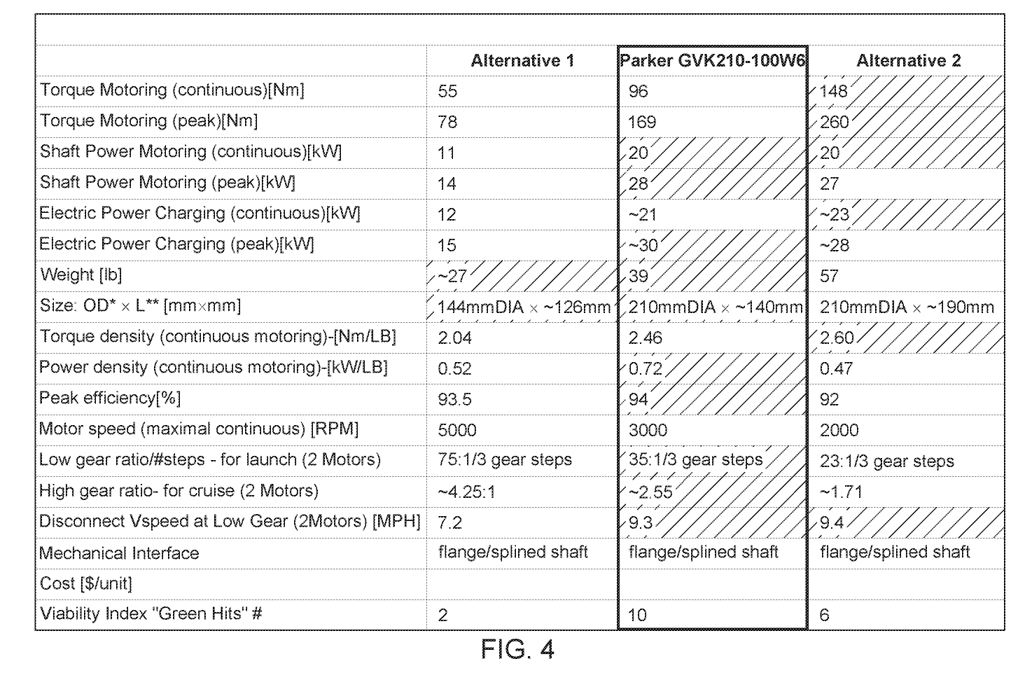

Turning now to FIG. 2, a graph of desired gear ratio 152 and disconnect speed 156 versus electric motor/generator stall torque 150 of an embodiment of an Electric Tag Axle 80 is shown. The desired overall gear ratio 154 is represented by a decreasing exponential or inverse logarithmic line 154. The desired disconnect vehicle speed is represented by an increasing linear line 158. Note that lines 154 and 158 intersect near the chosen 65:1 overall gear reduction ratio in low gear from the electric motor/generator 92 to the rearward rear wheels 84, and that the intersection lies both within the feasible motor size area 160 and within the feasible gear ratio area 162. FIG. 3 is a graph of operation modes speed ranges 180 of an embodiment of an Electric Tag Axle 80, giving vehicle speeds 182 when in each of the operational modes, including the low range motoring mode, the high range motoring mode/regenerative braking mode, and the neutral mode. FIG. 4 is a spreadsheet comparison of the chosen electric motor/generator 92 performance specifications, as compared to two other similar electric motor/generators.

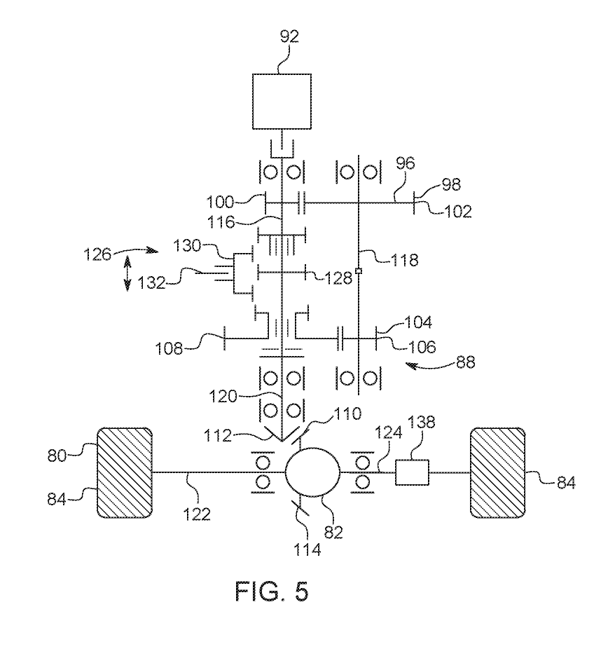

Referring now to FIG. 5, a graphical representation of an embodiment of an Electric Tag Axle 80 having rearward rear wheels 84 is shown. The Electric Tag Axle 80 is provided with an electric motor/generator 92, which is connected to a two speed gearbox 88. The two speed gearbox 88 is connected to an electric tag axle differential 82 of the Electric Tag Axle 80. The Electric Tag Axle 80 may be further provided with at least one single wheel disconnect mechanism 138. The two speed gearbox 88 has a set of low range gears 96, which includes a first gear pair 98 having a first gear 100 and a second gear 102, and a second gear pair 104 having a third gear 106 and a fourth gear 108. When the two speed gearbox 88 is in low range, power from the electric motor/generator 92 is transmitted to the first gear 100 of the first gear pair 98 by way of a first shaft 116. The first gear 100 transmits power to the second gear 102 at a 3.866:1 reduction ratio. The second gear 102 transmits power to the third gear 106 of the second gear pair 104 by way of a second shaft 118. The third gear 106 of the second gear pair 104 transmits power to the fourth gear 108 at a 3.866:1 reduction ratio. The fourth gear 108 transmits power to the third gear pair 110 by way of a third shaft 120. The third gear pair 110 includes a fifth gear 112 or pinion gear, and a sixth gear 114 or ring gear of the electric tag axle differential 82.

When the two speed gearbox 88 is in high range, power from the electric motor/generator 92 is transmitted directly from the first shaft 116 to the third shaft 120. A range selector 126, which includes a selector spline 128, a selector sleeve 130, and a shift fork 132, is used to select between the low range wherein power passes through the low range gears 96, and the high range wherein power passes directly from the first shaft 116 to the third shaft 120. In either case, power is transmitted from the third shaft 120 to the fourth and fifth shafts, 122 and 124, which may be referred to as axle shafts, by way of the third gear pair 110 at a reduction ratio of 4.35:1, and by way of the electric tag axle differential 82. In this way, the vehicle energy management system (not shown in FIG. 5) can choose between an overall reduction ratio of 4.35:1 in high range and 65:1 in low range. When neutral operation is desired, the vehicle energy management system may disengage the at least one single wheel disconnect mechanism 138, so that the spider gears of the tag axle differential 82 freewheel, thereby transmitting no power between the fourth and fifth shafts, 122 and 124, and the third shaft 120. The at least one single wheel disconnect mechanism 138 may be embodied as two single wheel disconnect mechanisms, one in each of the fourth and fifth shafts, 122 and 124, of the Electric Tag Axle 80. In this way, when neutral operation is desired, the vehicle energy management system may disengage both single wheel disconnect mechanisms in both of the fourth and fifth shafts, 122 and 124, thereby transmitting no power between the fourth and fifth shafts, 122 and 124, and the electric tag axle differential 82. Again, these embodiments minimize friction drag losses, and minimize wear and tear on the two speed gearbox 88 and electric motor/generator 92.

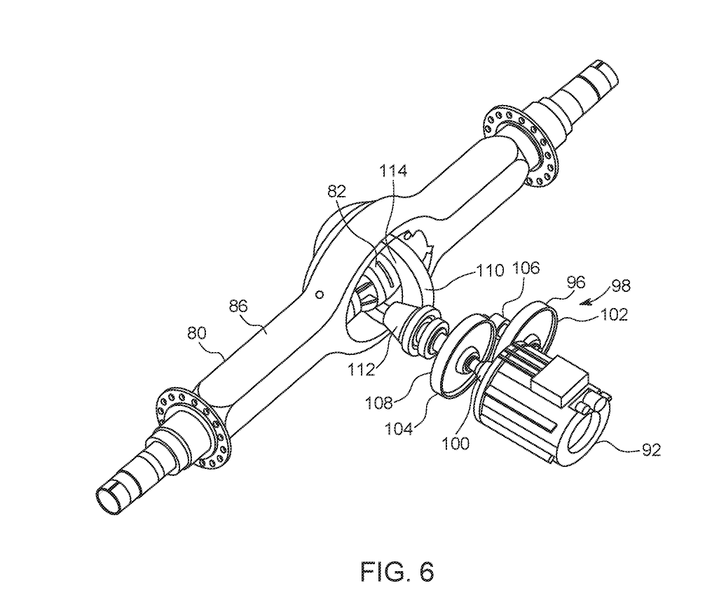

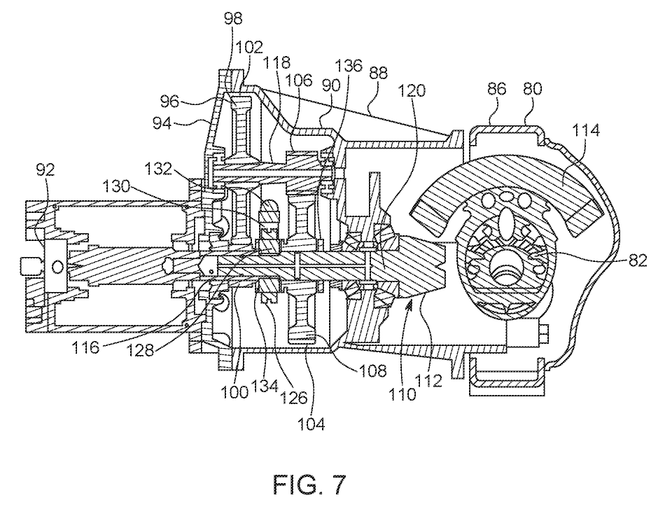

Referring now to FIGS. 6 and 7, a top right cutaway view and a left cutaway view is shown of an embodiment of an Electric Tag Axle 80 having an axle housing 86. The Electric Tag Axle 80 is again provided with an electric motor/generator 92, which is connected by way of an adapter plate 94 to a two speed gearbox 88 having a two speed gearbox housing 90. The two speed gearbox 88 is connected to the electric tag axle differential 82. The two speed gearbox 88 has a set of low range gears 96, which includes first gear pair 98 having first gear 100 and second gear 102, and second gear pair 104 having third gear 106 and fourth gear 108. When the two speed gearbox 88 is in low range, power from the electric motor/generator 92 is transmitted to the first gear 100 of the first gear pair 98 by way of first shaft 116. The first gear 100 transmits power to the second gear 102 at a 3.866:1 reduction ratio. The second gear 102 transmits power to the third gear 106 of the second gear pair 104 by way of second shaft 118. The third gear 106 of the second gear pair 104 transmits power to the fourth gear 108 at a 3.866:1 reduction ratio. The fourth gear 108 transmits power to the third gear pair 110 by way of third shaft 120. The third gear pair 110 includes fifth gear 112 or pinion gear, and sixth gear 114 or ring gear of the electric tag axle differential 82.

When the two speed gearbox 88 is in high range, power from the electric motor/generator 92 is again transmitted directly from the first shaft 116 to the third shaft 120. A range selector 126, which includes a selector spline 128, a selector sleeve 130, and a shift fork 132, is used to select between the low range wherein power passes through the low range gears 96, and the high range wherein power passes directly from the first shaft 116 to the third shaft 120. This may be accomplished using a high range clutch 134 between the first shaft 116 and the third shaft 120, and a low range clutch 136 between the third shaft 120 and the fourth gear 108 of the second gear pair 104. Alternately, the low range clutch 136 may be positioned between the first shaft 116 and the first gear 100 of the first gear pair 98. In each case, power is transmitted from the third shaft 120 to the fourth and fifth shafts, 122 and 124, which may be referred to as axle shafts, by way of the third gear pair 110 at a reduction ratio of 4.35:1, and by way of the electric tag axle differential 82. In this way, the vehicle energy management system 30 (not shown in FIGS. 6 and 7) can choose between an overall reduction ratio of 4.35:1 in high range and 65:1 in low range. When neutral operation is desired, the vehicle energy management system 30 may again disengage the at least one single wheel disconnect mechanism (not shown in FIGS. 6 and 7), so that the spider gears of the tag axle differential 82 freewheel, or so that no power is transmitted from the fourth and fifth shafts 122 and 124 and the tag axle differential 82, thereby transmitting no power between the fourth and fifth shafts, 122 and 124, and the third shaft 120. Again, this minimizes friction drag losses, and minimizes wear and tear on the two speed gearbox 88 and electric motor/generator 92.

While the Electric Tag Axle has been described with respect to at least one embodiment, the Electric Tag Axle can be further modified within the spirit and scope of this disclosure, as demonstrated previously. This application is therefore intended to cover any variations, uses, or adaptations of the Electric Tag Axle using its general principles. Further, this application is intended to cover such departures from the present disclosure as come within known or customary practice in the art to which the disclosure pertains and which fall within the limits of the appended claims.

REFERENCE NUMBER LISTING

| | |
|---|---|
| 10 | Vehicle |
| 12 | Chassis |
| 14 | Frame |
| 16 | Engine |
| 18 | Transmission |
| 20 | Driveshaft |
| 30 | Vehicle energy management system |
| 32 | Controller |
| 34 | Traction battery pack |
| 40 | Front drive/non-drive axle |
| 42 | Front wheels |
| 50 | Rear tandem axle assembly |
| 60 | Forward rear drive axle |
| 62 | Forward rear drive axle input |
| 64 | Forward rear drive axle differential |
| 66 | Forward rear wheels |
| 80 | Electric tag axle |
| 82 | Electric tag axle differential |
| 84 | Rearward rear wheels |
| 86 | Axle housing |
| 88 | Two speed gearbox |
| 90 | Two speed gearbox housing |
| 92 | Electric motor/generator |
| 94 | Adapter plate |
| 96 | Low range gears |
| 98 | First gear pair |
| 100 | First gear |
| 102 | Second ear |
| 104 | Second gear pair |
| 106 | Third gear |
| 108 | Fourth gear |
| 110 | Third gear pair |
| 112 | Fifth gear/pinion gear |
| 114 | Sixth gear/ring gear |
| 116 | First shaft |
| 118 | Second shaft |
| 120 | Third shaft |
| 122 | Fourth shaft |
| 124 | Fifth shaft |
| 126 | Range selector |
| 128 | Selector spline |
| 130 | Selector sleeve |
| 132 | Shift fork |
| 134 | High range clutch |
| 136 | Low range clutch |
| 138 | Single wheel disconnect mechanism |
| 150 | Electric motor/generator stall torque |
| 152 | Desired gear ratio |
| 154 | Desired overall gear ratio |
| 156 | Disconnect speed |
| 158 | Desired disconnect vehicle speed |
| 160 | Feasible motor sizes |
| 162 | Feasible gear ratio |
| 180 | E-tag operation modes speed ranges |
| 182 | Vehicle speed |

What is claimed is:

1. A vehicle, comprising:
a chassis;
an engine attached to the chassis;
a transmission connected to the engine;
a forward rear drive axle attached to the chassis and driven by the transmission; and
an electric tag axle attached to the chassis, the electric tag axle having a longitudinally arranged electric motor/generator connected to a two speed gearbox, the two speed gearbox being connected to a differential of the electric tag axle.

2. The vehicle of claim 1, further comprising:
a traction battery pack.

3. The vehicle of claim 2, wherein:
the electric tag axle is further provided with at least one single wheel disconnect mechanism.

4. The vehicle of claim 3, further comprising:
a vehicle energy management system having at least one of:
a vehicle controller,
a transmission controller,
an engine controller, and
an axle controller;
the vehicle energy management system being connected to at least one of:
the engine,
the transmission,
the traction battery pack,
the electric motor/generator,
the two speed gearbox, and
the at least one single wheel disconnect mechanism.

5. The vehicle of claim 4, wherein:
the vehicle energy management system being configured to at least one of:
engage the electric motor/generator to provide power to the electric tag axle using energy stored in the traction battery pack, and place the two speed gearbox in low gear in a low range motoring mode, and control the amount of power being provided by the electric motor/generator,
engage the electric motor/generator to provide power to the electric tag axle using energy stored in the traction battery pack, and place the two speed gearbox in high gear in high range motoring mode, and control the amount of power being provided by the electric motor/generator,
engage the electric motor/generator and place the two speed gearbox in high gear to recapture power from the electric tag axle and store the recaptured power in the traction battery pack in a regenerative braking mode, and control the amount of power being recaptured by the electric motor/generator, and
disengage the at least one single wheel disconnect mechanism in a neutral mode.

6. The vehicle of claim 5, wherein:
the electric motor/generator being capable of about 20 kilowatt (kW) continuous and about 28 KW peak shaft power, and being capable of about 21 KW continuous and about 30 kW peak power charging, at about 48 volt direct current (DC).

7. The vehicle of claim 5, wherein:
the two speed gearbox can selectively provide a 1:1 ratio in a high range, and about a 14.9:1 reduction ratio by way of two gear pairs having about a 3.866:1 reduction ratio each in a low range.

8. The vehicle of claim 7, wherein:
the two speed gearbox being connected to the differential of the electric tag axle by way of a ring gear and a pinion gear, the ring gear and the pinion gear providing about a 4.35:1 reduction ratio, so that an overall reduction ratio from the electric motor/generator to a drive wheel of the electric tag axle is either about 4.35:1 in the high range or about 65:1 in the low range.

9. The vehicle of claim 5, wherein:
the vehicle controller commands an operation state between the low range motoring mode, the high range motoring mode, the regenerative braking mode, and the neutral mode, and further controls the amount of power being provided by the electric motor/generator or the amount of power being recaptured by the electric motor/generator; and
the axle controller controls a transition between modes by way of at least one of a range selector and at least one clutch.

10. An electric tag axle of a vehicle, comprising:
an axle housing;
a differential contained within the axle housing and connected to two axle shafts;
a two speed gearbox connected to the differential by way of a ring gear and a pinion gear;
a longitudinally arranged electric motor/generator connected to the two speed gearbox.

11. The electric tag axle of claim 10, further comprising:
at least one single wheel disconnect mechanism connected to at least one of the two axle shafts.

12. The electric tag axle of claim 11, further comprising:
a vehicle energy management system contained within at least one of:
a vehicle controller,
a transmission controller,
an engine controller, and
an axle controller;
the vehicle energy management system being connected to at least one of:
an engine of the vehicle,
a transmission of the vehicle,
a traction battery pack of the vehicle,
the electric motor/generator,
the two speed gearbox, and
the at least one single wheel disconnect mechanism.

13. The electric tag axle of claim 12, wherein:
the vehicle energy management system being configured to at least one of:
engage the electric motor/generator to provide power to the electric tag axle using energy stored in the traction battery pack, and place the two speed gearbox in low gear in a low range motoring mode, and control the amount of power being provided by the electric motor/generator,
engage the electric motor/generator to provide power to the electric tag axle using energy stored in the traction battery pack, and place the two speed gearbox in high gear in high range motoring mode, and control the amount of power being provided by the electric motor/generator,
engage the electric motor/generator and place the two speed gearbox in high gear to recapture power from the electric tag axle and store the recaptured power in the traction battery pack in a regenerative braking mode, and control the amount of power being recaptured by the electric motor/generator, and
disengage the at least one single wheel disconnect mechanism in a neutral mode.

14. The electric tag axle of claim 13, wherein:
the electric motor/generator being capable of about 20 kilowatt (kW) continuous and about 28 KW peak shaft power, and being capable of about 21 KW continuous and about 30 kW peak power charging, at about 48 volt direct current (DC).

15. The electric tag axle of claim 13, wherein:
the two speed gearbox can selectively provide a 1:1 ratio in a high range, and about a 14.9:1 reduction ratio by way of two gear pairs having about a 3.866:1 reduction ratio each in a low range.

16. The electric tag axle of claim 15, wherein:
the ring gear and the pinion gear providing about a 4.35:1 reduction ratio, so that an overall reduction ratio from the electric motor/generator to a drive wheel of the electric tag axle is either about 4.35:1 in the high range or about 65:1 in the low range.

17. The electric tag axle of claim 13, wherein:
the vehicle controller commands an operation state between the low range motoring mode, the high range motoring mode, the regenerative braking mode, and the neutral mode, and further controls the amount of power being provided by the electric motor/generator or the amount of power being recaptured by the electric motor/generator; and
the axle controller controls a transition between modes by way of at least one of a range selector and at least one clutch.

18. A method of controlling an electric tag axle of a vehicle, comprising the steps of:
connecting a two speed gearbox to a differential of the electric tag axle by way of a ring gear and a pinion gear, the differential being connected to two axle shafts;
connecting a longitudinally arranged electric motor/generator to the two speed gearbox;
connecting at least one single wheel disconnect mechanism to at least one of the two axle shafts;
connecting a vehicle energy management system to at least one of:
an engine of the vehicle,
a transmission of the vehicle,
a traction battery pack of the vehicle,
the electric motor/generator,
the two speed gearbox, and
the at least one single wheel disconnect mechanism configuring the vehicle energy management system to at least one of:
engage the electric motor/generator to provide power to the electric tag axle using energy stored in the traction battery pack, and place the two speed gearbox in low gear in a low range motoring mode, and control the amount of power being provided by the electric motor/generator,
engage the electric motor/generator to provide power to the electric tag axle using energy stored in the traction battery pack, and place the two speed gearbox in high gear in high range motoring mode, and control the amount of power being provided by the electric motor/generator,
engage the electric motor/generator and place the two speed gearbox in high gear to recapture power from the electric tag axle and store the recaptured power in the traction battery pack in a regenerative braking mode, and control the amount of power being recaptured by the electric motor/generator, and
disengage the at least one single wheel disconnect mechanism in a neutral mode.

19. The method of claim 18, wherein:
The vehicle energy management system further comprises a vehicle controller and an axle controller;
the vehicle controller being configured to command an operation state between the low range motoring mode, the high range motoring mode, the regenerative braking mode, and the neutral mode, and further configured to control the amount of power being provided by the electric motor/generator or the amount of power being recaptured by the electric motor/generator; and
the axle controller being configured to control a transition between modes by way of at least one of a range selector and at least one clutch.

20. The method of claim 18, wherein:
the electric motor/generator being capable of about 20 kilowatt (kW) continuous and about 28 KW peak shaft power, and being capable of about 21 KW continuous and about 30 kW peak power charging, at about 48 volt direct current (DC);
the two speed gearbox can selectively provide a 1:1 ratio in a high range, and about a 14.9:1 reduction ratio by way of two gear pairs having about a 3.866:1 reduction ratio each in a low range; and
the ring gear and the pinion gear providing about a 4.35:1 reduction ratio, so that an overall reduction ratio from the electric motor/generator to a drive wheel of the electric tag axle is either about 4.35:1 in the high range or about 65:1 in the low range.
